(19) United States
(12) Patent Application Publication
(10) Pub. No.: US 2024/0367354 A1
(43) Pub. Date: Nov. 7, 2024

(54) METHODS OF FABRICATING CURVED TWO-DIMENSIONAL MEMBRANES AND MEMBRANES THEREOF

(71) Applicant: National University of Singapore, Singapore (SG)

(72) Inventors: Daria Andreeva-Baeumler, Singapore (SG); Konstantin Novoselov, Singapore (SG)

(21) Appl. No.: 18/692,691

(22) PCT Filed: Sep. 16, 2022
(86) PCT No.: PCT/SG2022/050667

§ 371 Date: Mar. 15, 2024

(30) Foreign Application Priority Data
Sep. 17, 2021 (SG) 10202110288S

(51) Int. Cl. B29C 41/08; B28B 1/26; B29C 41/38; B29C 41/50; B29K 81/00; B29K 105/04; B29L 31/00; B33Y 80/00

(52) U.S. Cl. CPC B29C 41/08; B28B 1/263; B28B 1/265; B29C 41/38; B29C 41/50; B29K 2081/06; B29K 2105/04; B29K 2995/0097; B29L 2031/757; B33Y 80/00

(57) ABSTRACT

The present disclosure concerns a method of fabricating a curved 2D membrane comprising providing a curved polymer template on a support, flowing a solution of 2D material through the curved polymer template in order to form 2D multilayers on the curved polymer template and separating the 2D multilayers from the curved polymer template in order to form the curved 2D membrane. The curved 2D membrane is 10 characterised by a hyperbolic paraboloid curvature. The curved 2D membrane is characterised by a multi-layered lamellar morphology.

### TECHNICAL FIELD

The present invention relates, in general terms, to methods of fabricating curved 2D membranes and the membranes thereof.

### BACKGROUND

Two-dimensional (2D) material-based thin films such as graphene oxide (GO) paper, zeolite nanosheet membranes, metal oxide nanosheets, and transition metal carbides/carbonitrides (MXenes) offer a wide range of applications for energy storage, stimuli-responsive membranes, acoustic transducing, flexible electronics, and actuators. In most applications, flat films and membranes are used. However, curved shapes such as hyperbolic paraboloid surfaces can be beneficial for new acoustic devices, self-cleaning membranes, and soft robotics due to their exceptional mechanical properties and their capability to switch between two equilibrium states, unturned and inverted shapes. One of the targeted application areas of such membranes can be the design of new acoustic diaphragms. For instance, the simulated acoustic diaphragm of a hyperbolic paraboloid shape provides more uniform directivity and improved power response. Furthermore, metamaterials with structural bistability can be used for the construction of stimuli-responsive elements for soft robotics. Hyperbolic paraboloid shaped elastomeric materials were used to mimic fish motion.

However, at this moment, there is lack of approaches and materials for forming curved 2D metamaterials. Various assembly methods such as vacuum filtration, evaporation, spin coating, and casting have been employed to prepare flat 2D membranes only. Curved 2D shapes can be prepared by pressing the flat film into a desired curved geometry by mechanical force. For example, curved diaphragms are prepared by “crimping” GO-based flat films. However, applying a mechanical force has the drawback of stretching the original flat film, which leads to internal stress accumulation, and affecting the film microstructure. Furthermore, the mechanical deformation of flat films is only suitable for creating simple shapes with low curvatures. Among other materials, elastomers were successfully used for the formation of hyperbolic paraboloid surfaces.

For example, a soft-robotic ray mimic can be fabricated using an elastomer in a saddle shape. However, elastomers have a bulk structure, relatively inert surface, a lack of functionality, and a limited application area. In contrast, the members of the 2D materials' family with their high surface-to-volume ratio, flexibility, tunable or controllable electronic and optical properties, are shown to be multifunctional materials with a broad technological area from membrane technology to flexible electronics and biomedical applications. Thus, curved 2D materials along with or in combination with soft matter can give us new functional materials that can be used to construct footprint devices with switchable electronic and optical properties as well as the capability to self-cleaning and antifouling.

It would be desirable to overcome or ameliorate at least one of the above-described problems.

### SUMMARY

The present disclosure relates to a fast and easy approach for constructing, among others, 2D saddle-shaped GO membranes with controllable curvature and thickness. The inventors formulated, and experimentally showed the feasibility of the presently disclosed method to prepare hyperbolic paraboloid 2D membranes with controllable thicknesses and curvatures. The invention is based on the development of new porous templates for the self-assembly of 2D nanosheets. The self-assembly provides the formation of a highly oriented lamellar texture. The thickness and curvature can be controlled with nanoscale precision by adjustment of self-assembly conditions. The new material demonstrates a highly ordered nanostructure typical for flat 2D analogous. Its robustness and ability to retain curved shapes are achieved due to the arrangement and stacking of nanosheets of GO. The method is adjustable such that other 2D materials such as metal dichalcogenides, MXenes, and 2D metal oxides can be used.

The present invention provides a method of fabricating a curved 2D membrane, comprising:
a) providing a curved polymer template on a support;
b) flowing a solution of 2D material through the curved polymer template in order to form 2D multilayers on the curved polymer template; and
c) separating the 2D multilayers from the curved polymer template in order to form the curved 2D membrane;
wherein the curved 2D membrane is characterised by a hyperbolic paraboloid curvature; and
wherein the curved 2D membrane is characterised by a multi-layered lamellar morphology.

In some embodiments, the curved polymer template is characterised by a hyperbolic paraboloid curvature.

In some embodiments, the curved polymer template is characterised by a curvature with a hyperbolic paraboloid surface function:

$$z = k \times ( {x}^{2} - {y}^{2} )$$

wherein k is a curvature coefficient.

In some embodiments, k is a value from about 0.1 to about 0.6.

In some embodiments, the curved polymer template is saddle shaped.

In some embodiments, the curved polymer template is formed from a thermoplastic polymer.

In some embodiments, the curved polymer template is formed from polyethersulfone (PES).

In some embodiments, the curved polymer template is fabricated by:
a) casting a polymer solution on a surface of a corresponding curved template in order to form a polymer layer;
b) immersing the polymer layer in a non-solvent in order to form a coagulated polymer layer; and
c) separating coagulated polymer layer from the corresponding curved template in order to form the curved polymer template.

In some embodiments, the polymer solution is characterised by a polymer concentration of about 10 wt % to about 30 wt %.

In some embodiments, the non-solvent is an aqueous medium.

In some embodiments, the immersion step is performed for at least 5 min.

In some embodiments, the immersion step is performed at a temperature of about 0° C. to about 70° C.

In some embodiments, the immersion step is performed at a temperature of about 25° C.

In some embodiments, the method further comprises a step of air drying the coagulated polymer layer before separating it from the corresponding curved template.

In some embodiments, the curved polymer template is characterised by a pore size of about 10 nm to about 50 nm.

In some embodiments, the curved polymer template is characterised by a pore size of about 20 nm.

In some embodiments, the curved polymer template is characterised by a thickness of about 50 μm to about 400 μm.

In some embodiments, the support comprises:
a) a base having a porous surface; and
b) a cap, the cap for mating with the base and configured to expose the porous surface of the base.

In some embodiments, the porous surface is characterised by a pore size of about 0.5 mm to about 2 mm.

In some embodiments, the base further comprises a stand, the porous surface provided on an end of the stand.

In some embodiments, the curved polymer template is positionable on the porous surface of the base.

In some embodiments, the curved polymer template is sandwiched between the base and the cap.

In some embodiments, the support is 3D printed.

In some embodiments, the support is configured to fit into a Buchner funnel.

In some embodiments, the flow step comprises filtering the solution of 2D material through the curved polymer template.

In some embodiments, the filtration is performed under a vacuum.

In some embodiments, the solution of 2D material comprises a 2D material selected from graphene oxide (GO), metal dichalcogenides, MXenes, 2D metal oxides, their combination, derivatives and analogs thereof.

In some embodiments, the solution of 2D material is characterised by a 2D material concentration of about 1 mg/ml to about 10 mg/mL.

In some embodiments, the method further comprises drying the 2D multilayers on the curved polymer template under air, N₂ or an inert gas.

In some embodiments, the drying step is performed at a temperature of about 15° C. to about 90° C.

In some embodiments, the separation step comprises peeling the 2D multilayers from the curved polymer template.

In some embodiments, the curved 2D membrane is characterised by a thickness of about 4 μm to about 20 μm.

In some embodiments, when the 2D material is GO, the curved 2D membrane is characterised by an interlayer distance of about 0.85 nm to about 0.95 nm.

In some embodiments, when the 2D material is GO, the curved 2D membrane is characterised by an interlayer distance of about 0.89 nm.

The present invention also provides a curved 2D membrane fabricated by the method as disclosed herein.

The present invention also provides a curved 2D membrane comprising a 2D material selected from graphene oxide (GO), metal dichalcogenides, MXenes, 2D metal oxides, their combination, derivatives and analogs thereof;
wherein the curved 2D membrane is characterised by a multi-layered lamellar morphology; and
wherein the curved 2D membrane is characterised by a hyperbolic paraboloid curvature.

### BRIEF DESCRIPTION OF THE DRAWINGS

Embodiments of the present invention will now be described, by way of non-limiting example, with reference to the drawings in which:

FIG. 1 shows a step by step process for the preparation of a saddle-shaped GO membranes.

FIG. 2 shows the geometry and dimensions of an insert with two separable parts: the base and the cap. All dimensions are in mm. (a, c) The images of designed 3D models. (b, d) the digital photos of disassembled 3D-printed insert: the base (b) and the cap (d).

FIG. 3 shows (a)-(e) SEM micrographs of the surfaces of PES templates prepared by phase inversion method at different coagulation bath temperatures, all the scale bars are 200 nm, and corresponding surface pore size distributions made by Image J. (f) Average pore size plotted vs. coagulation bath temperature. (g) SEM micrographs of the PES layer cross-section prepared by phase inversion method at 23° C. coagulation bath temperatures. (h) A smooth PES template prepared at optimal conditions. (i) In contrast to the smooth template (h) a rough PES template is not suitable for self-assembly of 2D layers.

FIG. 4 shows (a) photos of the same saddle-shaped GO membrane from several angles. (b) Thickness map of the saddle-shaped GO membrane. (c) SEM micrograph of the cross-sectioned saddle-shaped GO membrane. (d) XRD patterns of 15 μm flat GO film and different areas of the 14-μm-thick saddle-shaped GO film: 1, 2, and 3 are the lowest, middle, and the highest positions, respectively. (e) Point curvature of the template and the saddle-shaped GO membranes with different thicknesses.

### DETAILED DESCRIPTION

Hyperbolic paraboloid surfaces or saddle-shaped materials can exist in two equilibrium states when the saddle shape reverses on itself and, therefore, can be used as structural elements of new stimuli-responsive and shape-changing materials. Herein, a fast and easy approach to the self-assembly of two-dimensional (2D) nanosheets along or with a polymer to form curved interfaces is described. The method involves computer-aid designing, 3D printing, and casting curved templates for self-assembly of two-dimensional (2D) nanosheets. As an example, the feasibility of this method for self-assembly of graphene oxide flakes, and graphene oxide flakes with polymers is shown, though it can be expanded to include the whole family of 2D materials. The prepared free-standing saddle-shaped 2D membranes showed highly ordered nanostructure, typical for flat 2D multilayered materials. The physical organic preparation conditions was optimised to construct robust two-dimensional membranes with nanostructured architecture and controllable thickness and curvature. Such membranes can be used as bistable structures for the construction of new acoustic devices, flexible electronics, and membranes with self-cleaning and antifouling properties.

The present invention provides a method of fabricating a curved 2D membrane, comprising:
a) providing a curved polymer template on a support;
b) flowing a solution of 2D material through the curved polymer template in order to form 2D multilayers on the curved polymer template; and
c) separating the 2D multilayers from the curved polymer template in order to form the curved 2D membrane.

Comparing to other methods of the formation of curved 2D materials the presently disclosed method has the following advantages:
1) Suitable for creating a lot of variety of complex shapes with different curvature. In contrast, existing methods are suitable for creating simple shapes with low curvatures;
2) highly ordered nanostructure, typical observed for flat 2D multilayered materials. In contrast, other methods lead to stretching the original flat film, which leads to internal stress accumulation, and affecting the film microstructure;
3) easy and cheap preparation method;
4) the versatility of our technology offers almost unlimited design freedom for shape and structure geometry.
5) low cost of materials due to reduced technological steps.

The method of formation of layered active shape changing materials is low-cost, and is an easily up-scalable preparation technique for bistable structures that can be used for the construction of new acoustic devices, flexible electronics, and membranes with self-cleaning and antifouling properties. The technology involves computer-aid design, 3D printing, and casting curved templates for self-assembly of two-dimensional (2D) nanosheets in order to form robust two-dimensional membranes with nanostructured architecture and controllable thickness and curvature. The thickness and curvature of 3D-printed curved porous and non-porous insert for the fabrication of porous polymeric templates with controlled porosity and curvature can be controlled with nanoscale precision by adjustment of self-assembly conditions. The material demonstrates a highly ordered nanostructure typical for flat 2D analogs. The porous saddle-shaped templates for the self-assembly of 2D nanosheets such as hyperbolic paraboloid surfaces can control the self-assembly process. This fast and easy construction of curved 2D membranes can be integrated in devices (acoustic diaphragms, soft robotics, membranes, etc.). Improvements were further made to the filtration method to increase the thickness uniformity of the films such that free-standing films can retain the designed shape.

In some embodiments, the curved polymer template is characterised by a hyperbolic paraboloid curvature. In some embodiments, the curved polymer template is characterised by a curvature with a hyperbolic paraboloid surface function:

$$z = k \times ( {x}^{2} - {y}^{2} )$$

wherein k is a curvature coefficient. In some embodiments, k is a value from about 0.1 to about 0.6. In other embodiments, k is a value from about 0.1 to about 0.5, about 0.1 to about 0.4, about 0.2 to about 0.4, or about 0.3 to about 0.4.

In some embodiments, the curved polymer template is saddle shaped.

As the curved 2D membrane is formed on the curved polymer template, the curved 2D membrane also adopts a hyperbolic paraboloid curvature.

In some embodiments, the method of fabricating a curved 2D membrane, comprises:
a) providing a curved polymer template on a support;
b) flowing a solution of 2D material through the curved polymer template in order to form 2D multilayers on the curved polymer template; and
c) separating the 2D multilayers from the curved polymer template in order to form the curved 2D membrane;
wherein the curved 2D membrane is characterised by a hyperbolic paraboloid curvature.

In some embodiments, the curved polymer template is formed from a thermoplastic polymer. In some embodiments, the curved polymer template is formed from polyethersulfone (PES). In other embodiments, the curved polymer template is formed from a nonsolvent induced phase inversion method. Phase inversion or phase separation is a chemical phenomenon performed by removing the solvent from a liquid-polymer solution, leaving a porous, solid membrane. This may give a curved polymer template with a smooth surface.

Phase inversion can be carried out by reducing the temperature of the solution, by immersing the polymer solution into anti-solvent, exposing the polymer solution to a vapor of anti-solvent, and evaporating the solvent in atmospheric air or at high temperature. The rate at which phase inversion occurs and the characteristics of the resulting membrane are dependent on several factors, including solubility of solvent in the anti-solvent, insolubility of the polymer in the anti-solvent, and temperature of the anti-solvent.

In some embodiments, the curved polymer template is fabricated by:
a) casting a polymer solution on a surface of a corresponding curved template in order to form a polymer layer;
b) immersing the polymer layer in a non-solvent in order to form a coagulated polymer layer; and
c) separating coagulated polymer layer from the corresponding curved template in order to form the curved polymer template.

In some embodiments, the polymer solution is characterised by a polymer concentration of about 10 wt % to about 30 wt %. In other embodiments, the concentration is about wt % to about 25 wt %, about 10 wt % to about 20 wt %, or about 10 wt % to about wt %.

In some embodiments, the polymer solution comprises dimethylacetamide as a solvent. Other solvents that may be used include, tetrahydrofuran, 1,4-dioxane, chloroform, dichloromethane, and chlorobenzene.

In some embodiments, the polymer solution is degassed. The degassing can be performed for at least 12 h, at least 16 h, or at least 24 h.

In some embodiments, the non-solvent is an aqueous medium. The aqueous medium may be water. In other embodiments, the non-solvent is an alcohol, such as methanol, ethanol, propanol or butanol.

In some embodiments, the immersion step is performed for at least 5 min.

In some embodiments, the immersion step is performed at a temperature of about 0° C. to about 70° C. In this regard, the non-solvent is provided as a bath within this temperature range. In some embodiments, the immersion step is performed at a temperature of about 10° C. to about 70° C., about 10° C. to about 60° C., about 10° C. to about 50° C., about 10° C. to about 40° C., about 10° C. to about 30° C., or about 10° C. to about 20° C. In some embodiments, the immersion step is performed at a temperature of about 25° C.

In some embodiments, the method further comprises a step of air drying the coagulated polymer layer before separating it from the corresponding curved template.

In some embodiments, the curved polymer template is characterised by a pore size of about 10 nm to about 50 nm. In some embodiments, the curved polymer template is characterised by a pore size of about 20 nm. It was found that at this pore size range, the 2D materials are substantially retained on the curved polymer template in order to form the curved 2D membrane while allowing the solvent to flow through.

In some embodiments, the curved polymer template is characterised by a microporous morphology in its sublayer and by sub-micron pores in its surface layer. In some embodiments, the microporous morphology is an asymmetric structure with finger-like pores. This allows for optimal rate of solvent elimination as well as smooth surface for guided self-assembly of 2D nanosheets in highly-ordered multilayers with nanoscale precision.

In some embodiments, the curved polymer template is characterised by a thickness of about 50 μm to about 400 μm. In some embodiments, the curved polymer template is characterised by a thickness of about 50 μm to about 350 μm, about 50 μm to about 300 μm, about 50 μm to about 250 μm, about 50 μm to about 200 μm, or about 100 μm to about 200 μm.

The corresponding curved template used to form the curved polymer template may be characterised by a hyperbolic paraboloid curvature. For example, the corresponding curved template may be characterised by a curvature with a hyperbolic paraboloid surface function:

$$z = k \times ( {x}^{2} - {y}^{2} )$$

wherein k is a curvature coefficient. In some embodiments, the corresponding curved template is saddle shaped. In this regard, the curved profile is thus transferred to the curved polymer template.

In some embodiments, the corresponding curved template comprises a base and a cap. The cap fits over the base. The cap and/or the base comprises the curved profile as disclosed above. The cap is engageable with the base. For example, the cap may be frictionally engageable with the base such that the cap is not displaceable when a solvent is poured over the curved template. In this regard, the cap is sized such that its inner diameter is at least 0.3 mm larger than the outer diameter of the base, or at least 0.5 mm. The cap may comprise a centrally positioned hole. In use, the polymer template is positioned between the cap and the base when the cap is fitted onto the base. As a hole is present, the solution of 2D material can access the polymer template. The cap may further comprise inwardly formed edge. The inwardly formed edge allows for better engagement of the polymer template and/or the base. The inwardly formed edge may have a thickness of at least about 3 mm, or about 5 mm. The cap may comprise a flange at its bottom end. The flange may have a thickness of more than 1 mm, or about 1.5 mm.

The base may comprise a porous surface. The porous surface may comprise a plurality of holes. The porous surface may be located within the curved profile. The plurality of holes may be arrayed. The cap may further comprise a border, the plurality of holes being contained within the border. The border may have a thickness of about 1 mm to about 5 mm, or about 2 mm.

In combination, the polymer template is held between the cap and the base. A solution of 2D material can flow from the hole of the cap to the polymer template and away from the polymer template via the plurality of holes in the base. In some embodiments, the curved polymer template is positionable on the porous surface of the base. In some embodiments, the curved polymer template is sandwiched between the base and the cap.

Accordingly, in some embodiments, the corresponding curved template or support comprises:
a) a base having a porous surface; and
b) a cap, the cap for mating with the base and configured to expose the porous surface of the base.

The base may be sized such that it is about 0.2 mm to about 1 mm smaller than the cap. This allows a smooth but tight fit between the base and the cap such that the curved polymer template and/or the curved 2D membrane will not be distorted or torn during assembly or removal. In other embodiments, the gap is about 0.2 mm to about 0.8 mm, about 0.4 mm to about 0.8 mm, about 0.4 mm to about 0.6 mm, or about 0.5 mm.

In some embodiments, the porous surface is characterised by a pore size of about 0.5 mm to about 2 mm. In some embodiments, the pore size is about 0.5 mm to about 1.5 mm, or about 0.5 mm to about 1 mm. In some embodiments, the pore size is less than 1 mm, or about 0.7 mm.

In some embodiments, the base further comprises a stand, the porous surface provided on an end of the stand. The stand may be a flange at a bottom end of the base. The flange may have a thickness of more than 3 mm, or about 2 mm.

In some embodiments, the support is 3D printed.

Any commercially available polymeric, metallic and ceramic inks for 3D printing can be used to form the support.

In some embodiments, the support is configured to fit into a Buchner funnel.

In some embodiments, the flow step comprises filtering the solution of 2D material through the curved polymer template. During this process, the 2D material may self assemble to form a film. The 2D material may self assemble into a multi-layered morphology.

In some embodiments, the filtration is performed under a vacuum.

In some embodiments, the solution of 2D material comprises a 2D material selected from graphene oxide (GO), metal dichalcogenides, MXenes, 2D metal oxides, their combination, derivatives and analogs thereof.

The solution of 2D material may further comprise other components such as cellulose derivatives, chitosan, polyethyleneimine, and/or polyacrylonitrile fibers. By mixing these fillers with the 2D materials, a 2D composite membrane may be formed, which provides further additional advantages.

In some embodiments, the solution of 2D material is characterised by a 2D material concentration of about 1 mg/mL to about 10 mg/mL. In other embodiments, the concentration is about 1 mg/mL to about 9 mg/mL, about 1 mg/mL to about 8 mg/mL, about 1 mg/mL to about 7 mg/mL, about 1 mg/mL to about 6 mg/mL, about 1 mg/ml to about 5 mg/mL, about 1 mg/mL to about 4 mg/mL, about 1 mg/ml to about 3 mg/mL, or about 1 mg/mL to about 2 mg/mL.

In some embodiments, the method further comprises drying the 2D multilayers on the curved polymer template under air, N₂ or an inert gas.

In some embodiments, the drying step is performed at a temperature of about 15° C. to about 90° C. In other embodiments, the temperature is about 20° C. to about 90° C., about 30° C. to about 90° C., about 40° C. to about 90° C., about 50° C. to about 90° C., about 60° C. to about 90° C., or about 70° C. to about 90° C.

In some embodiments, the separation step comprises peeling the 2D multilayers from the curved polymer template.

In some embodiments, the curved 2D membrane is characterised by a thickness of about 4 μm to about 100 μm. It was found that the curved 2D membrane having this thickness range is at least able to maintain its curved morphology. In other embodiments, the thickness is about 4 μm to about 20 μm, about 6 μm to about 20 μm, about 8 μm to about 20 μm, about 10 μm to about 20 μm, about 12 μm to about 20 μm, about 14 μm to about 20 μm, or about 14 μm to about 18 μm. In some embodiments, the curved 2D membrane is characterised by a thickness of about 14 μm to about 100 μm, about 14 μm to about 90 μm, about 14 μm to about 80 μm, about 14 μm to about 70 μm, about 14 μm to about 60 μm, about 14 μm to about 50 μm, about 14 μm to about 40 μm, about 14 μm to about 30 μm, or about 14 μm to about 20 μm. In some embodiments, the curved 2D membrane is characterised by a thickness of more than 14 μm.

In some embodiments, the curved 2D membrane is characterised by a multi-layered lamellar morphology. The multilayered lamellar structure comprises layers of 2D materials stacked adjacent to each other. The interlayer distance between each layer may be about 0.6 nm to about 1 nm, or about 0.7 nm to about 0.9 nm, or about 0.89 nm. The interlayer distance between the layers was found to be consistent throughout the curvature of the curved membrane.

In some embodiments, when the 2D material is GO, the curved 2D membrane is characterised by an interlayer distance of about 0.85 nm to about 0.95 nm. In some embodiments, when the 2D material is GO, the curved 2D membrane is characterised by an interlayer distance of about 0.89 nm.

The present invention also provides a curved 2D membrane fabricated by the method as disclosed herein.

The present invention also provides a curved 2D membrane comprising a 2D material selected from graphene oxide (GO), metal dichalcogenides, MXenes, 2D metal oxides, their combination, derivatives and analogs thereof;
wherein the curved 2D membrane is characterised by a multi-layered lamellar morphology; and
wherein the curved 2D membrane is characterised by a hyperbolic paraboloid curvature.

In some embodiments, the 2D material is GO. In other embodiments, the 2D material is GO nanosheets. The GO nanosheets may be about 7 μm to about 10 μm.

In some embodiments, the curved 2D membrane is characterised by the 2D material being self assembled. Self assembly involves molecules or entities coming together spontaneously on a surface and without guidance from an external source to be organized into large ordered domains. The self assembled layer may in some cases not interact strongly with the substrate.

Accordingly, in some embodiments, the curved 2D membrane is characterised by the 2D material being organised in large order domains. The domains may be about 10 μm to about 5000 μm, or about 100 μm to about 3000 μm. In other embodiments, the domains are larger than 5000 μm.

The presently disclosed membranes can have applications in acoustic devices, architecture constructs, lightweight materials for architecture and smart housing, soft robotics, smart sensors, smart membranes.

### Self-Assembly of Hyperbolic Paraboloid 2D Membranes

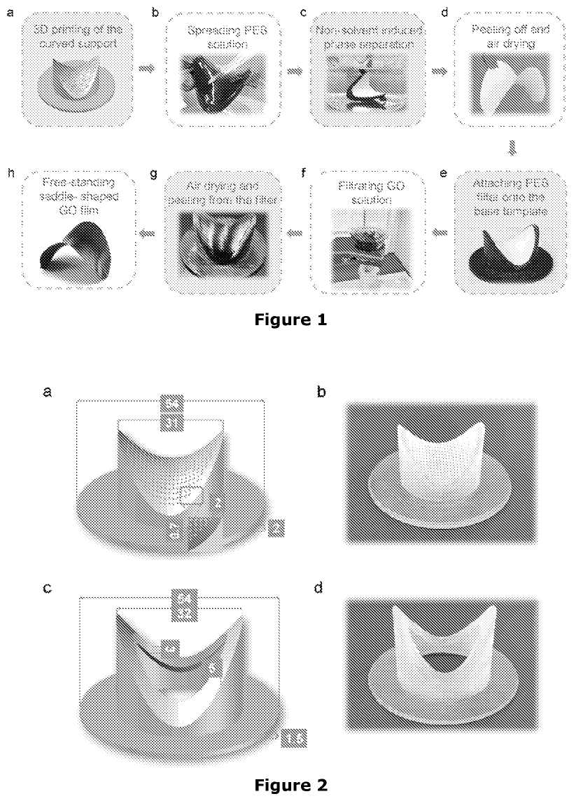

The technological steps for the preparation of saddle-shaped 2D membranes are illustrated in FIG. 1. The first step is to apply computer-aid-design software (Autodesk AutoCAD) and 3D printing to prepare curved templates of hyperbolic paraboloid shape. The second step is to optimize the conditions for casting polymeric layers with controlled porosity to provide mechanical support for the self-assembly of GO nanosheets and GO nanosheets decorated by polymers and guide the self-assembly process due to the regulated rate of solvent elimination from GO and GO-polymer suspension. The last step is the self-assembly of nanosheets in nanostructured 2D membranes with controllable thickness and curvature.

### Design and Fabrication of Saddle-Shaped Insert

In order to self-assemble the curved nanostructured membranes, we modified a traditionally used filtration setup for vacuum-assisted assembly of 2D multilayers. We designed curved inserts that can be added to the Buchner funnel on the top of frittered support (FIG. 1a).

To 3D design an insert, we applied the hyperbolic paraboloid surface function z=k×(x²−y²) using Autodesk AutoCAD software to draw curved models. In order to estimate the optimal geometrical parameters for the insert, we varied the curvature coefficients k between 0.2 and 0.4.

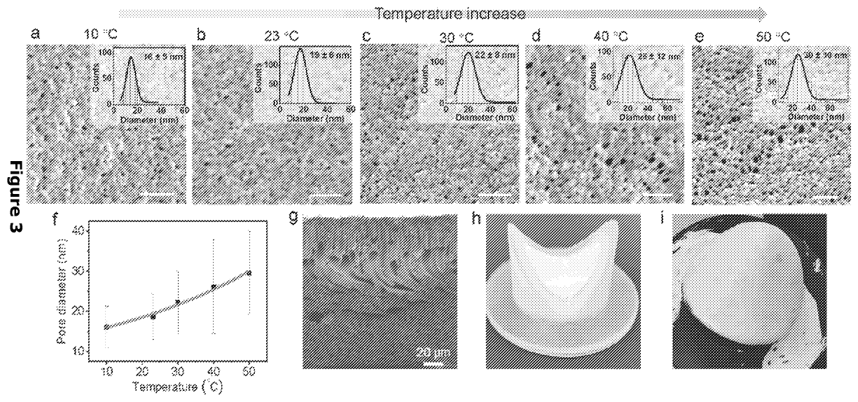

FIG. 2 shows the designed model and the 3D printed inserts. The insert has two mobile parts: the base and the cap. The cap is used to avoid leakage of solvents during the preparation process. The base can be disassembled from the cap to quickly and easily separate the prepared polymeric template from the curved surface of the insert. The diameter of the insert is chosen to be 47 mm to fit the filtration setup. To fit the base and the cap well, a 0.5 mm clearance (the gap between the base and the cap) is required. To make the template stable and fit with the clamp of the filtration setup, the edge thickness of the insert is set to be thicker than 1 mm. The hole size in the base is 0.7 mm, which is a limitation of the used 3D printer. However, such hole size is not suitable for assembling nanosheets (7-10 μm). To reduce the size of holes in the insert, we designed curved microporous polymeric templates and used them as support for the deposition of 2D layers. Additionally, we left the 2 mm width at the edge of the base curved surface without perforation to better fit the edge of the curved porous polymeric template and the cap, which also had a 5 mm protruding edge for better sealing.

### Preparation of Curved Porous Polymeric Template

Curved porous polymeric templates for self-assembly of 2D nanosheets were prepared by nonsolvent induced phase inversion method on the top of 3D-printed nonporous template from the solution of PES. PES is a cheap and robust polymeric material traditionally used as a component of polymeric, composite, and asymmetric membranes. PES is chemically resistive, has excellent mechanical properties and processibility. Nonsolvent induced phase inversion method leads to the formation of smooth polymeric surfaces essential for the further assembly of 2D layers.

We dissolved PES granules in DMAc solvent to obtain 10-30 wt % (or 15 wt %) PES solution. Other solvents such as tetrahydrofuran, 1,4-dioxane, chloroform, dichloromethane, and chlorobenzene can also be used. To eliminate bubbles from the PES solution, we left it for 24 h to degas. 1 mL of 15 wt % PES solution was spread evenly on a dry, clean, and smooth curved surface of the modified Buechner funnel (FIG. 1b). Then the template was immersed in a non-solvent such as de-ionized (DI) water or alcohols for 5 mins (FIG. 1c). After immersion, it was dried in the air. The white PES template was peeled off from the curved template and then attached to the perforated insert for self-assembly of 2D nanosheets (FIG. 1c-d). Before adding aqueous GO and GO-polymer suspension, the PES template was rinsed twice with DI water to remove residual solvent.

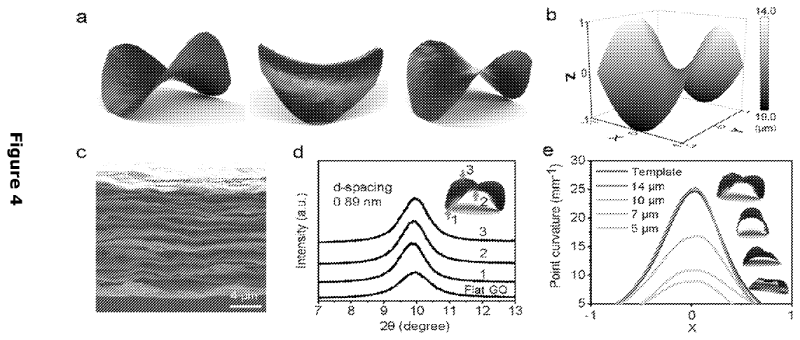

To form homogeneous and structured 2D layers, it is essential to form the polymeric template with optimal porosity. The porosity regulates the rate of solvent elimination from the suspensions of GO and, therefore, guides the self-assembly of 2D nanosheets. FIG. 3 (a-f) shows the SEM micrographs of the PES layers' top surfaces and the pore size distributions depending on the coagulation bath temperature used for the phase inversion. Analysis of SEM images was carried out using Image J to obtain pore size distributions. It is seen that pore size on the top surface tends to increase with an increase in temperature, which agrees with previously reported data. Higher temperature leads to enhanced intersolubility, which shrinks the liquid-liquid demixing region. Furthermore, the diffusion rates of solvent and nonsolvent molecules become faster, and the phase inversion process is accelerated. Therefore, the PES templates prepared at higher coagulation bath temperature exhibit a higher porosity.

The optimal pore size and distribution were achieved in the templates prepared at 23° C. (FIG. 3b). The cross-section of the PES template obtained at 23° C. shows a typical asymmetric structure with finger-like pores in the sublayer and sub-micron pores in the top skin layer (FIG. 3g). The total film thickness is in the range of 100-200 μm. By varying temperature and solvent, we can adjust the porosity and thickness of the curved PES template and the surface morphology. As we see in FIG. 2 (h) optimal PES template has a shiny, smooth surface. Obviously, the PES prepared at other conditions has a surface unsuitable for the self-assembly process (FIG. 3i). Thus, the optimal templates demonstrate both microporous morphology and relatively narrow pore size distribution for optimal rate of solvent elimination as well as smooth surface for guided self-assembly of 2D nanosheets in highly-ordered multilayers with nanoscale precision.

### Self-Assembly of Curved 2D Multilayers

FIG. 4 (a) demonstrates the obtained saddle-shaped 2D membranes. This particular membrane was prepared by self-assembly of 7-10 μm GO nanosheets from 2 mg/ml aqueous GO suspension. After the solvent elimination, the template with the GO film was dried in the air for 12 hours, and then the film was peeled off to obtain a free-standing curved GO film. The layer-by-layer staking of GO nanosheets and the lamellar morphology of hyperbolic paraboloid membranes is shown in the SEM images in FIG. 4 (c). To reveal the homogeneity of the curved membranes, we made the mapping of thickness distribution using the SEM images of the same sample but cross-sectioned in different areas. The thickness map plotted in FIG. 4 (b) demonstrates a 26% variance in the thickness of one membrane. This value can be improved by further adjustment of filtration parameters.

It is important to demonstrate that the nanostructure of the saddle-shaped membrane is analogous to those for the flat membrane. The XRD patterns obtained for flat and curved GO membranes revealed the presence (001)-peak location at around 10° (FIG. 4d). The d-spacing calculated from the XRD data for curved and flat GO samples shows that the interlayer distance is around 0.89 nm for both types of membranes. Furthermore, the XRD patterns show a uniform layered structure over the entire area of the curved membrane.

Finally, we revealed an optimal thickness of the GO membrane capable of keeping saddle shape. Obviously, the thickness of the curved GO membrane directly affects the ability of the free-standing membrane to keep the desired shape. FIG. 4 (e) shows that for highly curved samples, the shape of the free-standing film starts to deviate from the shape of the 3D model if the resulting film thickness is below 14 microns. It is believed that other factors like drying procedure, the humidity conditions of the environment, and the designed curvature can affect the resulting shape of the curved GO film. We would like to note that even the thinnest membranes still maintain negative Gaussian curvature, FIG. 4 (e), in accordance with Gauss's Theorema Egregium.

### CONCLUSIONS

A fast and easy method of self-assembly of hyperbolic paraboloid 2D membranes is disclosed herein. A 3D-printed insert for the fabrication of porous polymeric templates with controlled porosity and curvature was developed. The polymeric template was used to guide the self-assembly deposition of highly ordered layers of graphene oxide nanosheets. The versatility of our technology offers almost unlimited design freedom for shape and structure geometry. In particular, it is shown herein that creating suitable hyperbolic paraboloid surfaces can control the self-assembly process. It is shown herein that the structure and the curvature of 2D multilayered membranes could be accurately regulated by the porosity of the polymeric template and the thickness of multilayers. The microstructure of the hyperbolic paraboloid membranes is equal to those of flat 2D membranes. The thickness of the curved membranes seems to be the critical parameter affecting the ability of the free-standing films to retain the designed shape. Improvements to the filtration method are essential to increase the thickness uniformity of the films. Further studies on the effect of curvature, thickness, and process conditions on shape retention are needed. In general, a hyperbolic-paraboloid surface was used to demonstrate the feasibility of the method to construct shaped 2D membranes. The results suggest that the proposed technology is promising for fabricating curved 2D materials for various applications.

### EXAMPLES

### Materials

Polyethersulfone (PES, granules, 58,000 Mw) and N, N-Dimethylacetamide (DMAc, ≥99%) were obtained from Merck. Graphene Oxide water dispersion (0.4 wt %) was received from Graphenea (USA). Inc. UV sensitive Resin (UV wavelength 405 nm) for 3D printing was purchased from ANYCUBIC. Iso-Propyl alcohol (IPA, ≥99.8%) was obtained from Fisher Scientific.

### Software and 3D Printing Parameters

We used computer-aid-design software (Autodesk AutoCAD) and 3D printing to prepare curved inserts for the vacuum filtration setup. The designed template was exported to the stereolithography format file (STL) and sliced in Photon Workshop software). The following slicing parameters were used: layer thickness—0.05 mm; normal exposure time—2 s; off time—1 s; bottom exposure time—40 s; number of bottom layers—6. 3D printer (ANYCUBIC Photon Mono X), and Wash & Cure machine (ANYCUBIC) were used for 3D printing. After printing, the inserts were removed from the printing platform and washed with IPA for 10 mins. After air drying, the inserts were cured additionally for 5 mins.

### Characterization

The microscopic structure and the thickness of the PES templates and GO memebranes were observed by scanning electron microscope (SEM, Zeiss Sigma 300). Before observation, the membranes were fractured in liquid nitrogen (for cross-section) and coated with gold (˜10 nm). The average skin layer pore size of the PES templates was calculated by Image J. The curvature of the GO films was analyzed by Image J Kappa. The thin-film X-Ray Diffraction (XRD) patterns of GO film were collected by thin-film X-ray diffractometer (TF-XRD, Bruker D8 Advance) with Cu Kα radiation (λ=1.5418 Å), 0.02° increment and 1 s per step.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Throughout this specification and the claims which follow, unless the context requires otherwise, the phrase “consisting essentially of”, and variations such as “consists essentially of” will be understood to indicate that the recited element(s) is/are essential i.e. necessary elements of the invention. The phrase allows for the presence of other non-recited elements which do not materially affect the characteristics of the invention but excludes additional unspecified elements which would affect the basic and novel characteristics of the method defined.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A method of fabricating a curved 2D membrane, comprising:
a) providing a curved polymer template on a support;
b) flowing a solution of 2D material through the curved polymer template in order to form 2D multilayers on the curved polymer template; and
c) separating the 2D multilayers from the curved polymer template in order to form the curved 2D membrane;
wherein the curved 2D membrane is characterised by a hyperbolic paraboloid curvature; and
wherein the curved 2D membrane is characterised by a multi-layered lamellar morphology.

2. (canceled)

3. The method according to claim 1, wherein the curved polymer template is characterised by a curvature with a hyperbolic paraboloid surface function:
$$z = k \times ( {x}^{2} - {y}^{2} )$$
wherein k is a curvature coefficient;
wherein k is a value from about 0.1 to about 0.6.

4. The method according to claim 1, wherein the curved polymer template is saddle shaped.

5. (canceled)

6. The method according to claim 1, wherein the curved polymer template is fabricated by:
a) casting a polymer solution on a surface of a corresponding curved template in order to form a polymer layer;
b) immersing the polymer layer in a non-solvent in order to form a coagulated polymer layer; and
c) separating coagulated polymer layer from the corresponding curved template in order to form the curved polymer template;
wherein the polymer solution is characterised by a polymer concentration of about 10 wt % to about 30 wt %;
wherein the non-solvent is an aqueous medium.

7. (canceled)

8. (canceled)

9. The method according to claim 6, wherein the immersion step is performed for at least 5 min;
wherein the immersion step is performed at a temperature of about 0° C. to about 70° C.

10. (canceled)

11. The method according to claim 6, further comprising a step of air drying the coagulated polymer layer before separating it from the corresponding curved template.

12. The method according to claim 1, wherein the curved polymer template is characterised by a microporous morphology in its sublayer and by sub-micron pores in its surface layer,
wherein the sub-micron pores is characterised by a pore size of about 10 nm to about 50 nm, or preferably by a pore size of about 20 nm;
wherein the curved polymer template is characterised by a thickness of about 50 μm to about 400 μm.

13. (canceled)

14. The method according to claim 1, wherein the support comprises:
a) a base having a porous surface; and
b) a cap for mating with the base and configured to expose the porous surface of the base;
wherein the porous surface of the base is characterised by a pore size of about 0.5 mm to about 2 mm.

15. (canceled)

16. The method according to claim 14, wherein the base further comprises a stand, the porous surface provided on an end of the stand.

17. The method according to claim 14, wherein the curved polymer template is positionable on the porous surface of the base and sandwiched between the base and the cap.

18. The method according to claim 1, wherein the support is 3D printed and/or wherein the support is configured to fit into a Buchner funnel.

19. (canceled)

20. The method according to claim 1, wherein the flow step comprises filtering the solution of 2D material through the curved polymer template.

21. The method according to claim 1, wherein the filtration is performed under a vacuum.

22. The method according to claim 1, wherein the solution of 2D material comprises a 2D material selected from graphene oxide (GO), metal dichalcogenides, MXenes, 2D metal oxides, their combination, derivatives and analogs thereof; wherein the solution of 2D material is characterised by a 2D material concentration of about 1 mg/mL to about 10 mg/mL.

23. (canceled)

24. The method according to claim 1, further comprising drying the 2D multilayers on the curved polymer template under air, N₂ or an inert gas; wherein the drying step is performed at a temperature of about 15° C. to about 90° C.

25. (canceled)

26. The method according to claim 1, wherein the separation step comprises peeling the 2D multilayers from the curved polymer template.

27. method according to claim 1, wherein the curved 2D membrane is characterised by a thickness of about 4 μm to about 20 μm.

28. The method according to claim 1, wherein when the 2D material is GO, the curved 2D membrane is characterised by an interlayer distance of about 0.85 nm to about 0.95 nm.

29. A curved 2D membrane fabricated by the method according to claim 1.

30. A curved 2D membrane comprising a 2D material selected from graphene oxide (GO), metal dichalcogenides, MXenes, 2D metal oxides, their combination, derivatives and analogs thereof;
wherein the curved 2D membrane is characterised by a multi-layered lamellar morphology; and
wherein the curved 2D membrane is characterised by a hyperbolic paraboloid curvature.
